(19) United States
(12) Patent Application Publication
(10) Pub. No.: US 2004/0049976 A1
(43) Pub. Date: Mar. 18, 2004

(54) Plant protection device and method

(76) Inventor: James Anthony Maffei, Standish, ME (US)

Correspondence Address: BOHAN, MATHERS & ASSOCIATES, LLC, PO BOX 17707, PORTLAND, ME, 04112-8707, US

(21) Appl. No.: 10/661,301

(22) Filed: Sep. 12, 2003

Related U.S. Application Data
(60) Provisional application No. 60/410,401, filed on Sep. 13, 2002.

(51) Int. Cl. A01G 13/02

(52) U.S. Cl. 47/20.1

(57) ABSTRACT

A protective enclosure for protecting garden plants against frost and other environmental hazards. The enclosure consists of semi-circular arches over which a protective cover is deployed. The cover is held in place by elastic hold-downs strung across the outside of the cover at each arch. Each arch presents to the hold-down a concave shape that receives and stabilizes the hold-down element. The cover is translucent to sunlight and may include two types of material, one impervious to wind and rain, the other a mesh transparent to wind and rain. The wind-impervious material may be bunched up under the hold-downs, leaving plants protected only by the mesh. Access to plants is gained by lifting and bunching up the mesh, which is re-deployed when access is no longer necessary.

### BACKGROUND OF THE INVENTION

1. Field of Invention

This invention relates to gardening. More particularly, it relates to devices and methods for protecting garden plants against weather conditions and insects adverse to the healthy growth of such plants. More particularly still, this invention relates to covers used for protecting row-planted garden plants and to the use of such covers.

2. Description of Prior Art

Home gardening and small-scale gardening to supply roadside stands constitute widespread and generally enjoyable activities in the temperate climate zones of the world. Where it is undertaken, there are a number of natural conditions that limit its effectiveness if not to say enjoyableness. Of these, late Spring frost and early Autumn frost rank very high in their impact, both having the capability of destroying an entire crop overnight. Additional perennial hazards include wind, hail, insects, birds, and inappropriate rainfall, whether excessive or deficient. In addition, there are arable areas of the country where the average growing season is too short for most plants of interest. Even though the frost-free season is sufficiently long, the period during which temperatures are actually high enough to stimulate the growth of plants is not. This is commonly the case on islands off the Northeastern United States and the Maritime Provinces of Canada. Although greenhouses provide good protection from these hazards and can extend the effective growing season, they can be impractical for small-scale growers. Also, they are not necessary for much of the growing season in the warmer parts of the temperate zone.

Various approaches have been undertaken in an attempt to produce protective devices that are less permanent and less expensive than greenhouses. One, referred to as the “Water Fence”, is a cellular, multi-tube, transparent plastic structure, designed to be filled with water and deployed over the plants to be protected. The specific heat of the water modulates temperature fluctuations at the position of the plants themselves, thus protecting them from frost, provided that the ambient air temperature does not fall far below freezing for extended times. This Water Fence is translucent so that it can be, and is intended to be, left in place during the days as well as frosty nights. While the Water Fence offers protection from frost and wind, it is not effective against high winds, hail, and insect infestation. Also, it is intended to be used at the start of a growing season and the plants quickly outgrow it. Additionally, it is cumbersome to deploy, and tends to break easily because of the weight of the water it has to support. Also, the water it contains as an intrinsic feature is susceptible to algae growth, which increases the opacity of the cover, with the obvious detrimental consequences for the growth of the plants it is protecting. In general, any of the prior-art covers that are sufficient to give frost protection and wind protection tend to reduce the solar radiation available to the plant to a degree that is detrimental to plant growth. Thus, there is a great incentive not to leave these covers on during periods when frost is not a concern. Thus, they are limited in the protection they provide against insects and many other ambient hazards.

Then there is the Garden Umbrella, which, as the name implies, is designed to be placed directly over one or a few plants, like an umbrella. Although it is easy to deploy, a large number must be used to protect an entire garden. Also, though it retards the radiation from the plants that can lead to frost on cold, clear nights, it is not that good at frost protection, since it leaves the plants in contact with ambient air. Also it does nothing to guard against insects and very little to protect against wind. Indeed, because of its structure, it is itself vulnerable to high winds.

There is an entire class of plant protectors that are categorized as “row protectors,” since they are designed to cover a linear array of plants, such as grow in one or several adjoining rows in a garden. They all generally take the form of an extended, translucent plastic sheet laid over support arches that are lined up along and span the row to be protected. These row protectors have the advantage of being more portable and flexible than greenhouses. Nevertheless, those of which the present inventor has knowledge have several serious drawbacks. Some of them have supports made of metal, which heats up due to insulation, with the result that the elevated temperatures accelerate the deterioration of the plastic cover. Also, the metal supports rust and abrade the covers, and generally become unsightly over time. When the supports are wood, the drawbacks are rot and loss of strength as time passes. The biggest criticism of the supports of traditional row covers is that they do nothing but support the plastic cover. They do not contribute to the security of the system, and as a consequence, additional components have to be added to it, reducing the flexibility and introducing drawbacks of their own. In particular, to ensure that the cover remains on the supports under windy conditions, the prior-art row cover systems usually affix the covers to the supports by staples or other affixing means deployed at specific locations on the supports. Unfortunately, this approach is vulnerable to failure in moderate to high winds, since the spatial localization of the affixing technique causes enhanced stress at those points. This can and does lead to tearing of the plastic cover and potentially a sudden and complete ripping away, that is, failure, of the cover.

Another or an additional approach to holding down the cover is to attach weights to the cover's outer longitudinal edges. The weight is distributed longitudinally and, if used by itself, does serve to delocalize the stress applied to the cover during windy conditions. See, for example, the system taught by Robinson (U.S. Pat. No. 4,856,228). Robinson describes an inflatable tunnel for row crops, wherein the cover is held up by air pressure within inflatable ribs that are integral to the cover. Water-filled ballasts serve as the longitudinal weights. Unfortunately, because of the unitary nature of the Robinson device, the cover cannot easily be removed for venting, plant maintenance, or harvesting.

The Floating Row Cover avoids the problems associated with the support arches of the previously described row covers. It consists of a translucent plastic sheet draped directly across a bed of plants. While it provides some frost protection, it does not protect against wind. Further, it inhibits plant growth because it rests directly on the plants. Additionally, routine tending of the plants, such as should be done in all gardens, is burdensome because the device needs to be lifted from, and then re-secured to, the ground each time access to the plants is desired or necessary.

Koziol (U.S. Pat. No. 3,812,616) and Anderson (U.S. Pat. No. 4,665,646) each describe a protective enclosure that includes a series of arched supports extending the length of a row and a translucent plastic cover draped over the supports. The cover of both the Koziol and Anderson enclosures is reversibly affixed to the supports by a series of clamps located at the bottom of the individual arches. With the clamps released, the cover can be rolled along the supports to the top where a retaining member can be inserted to hold the cover in place. The cover is intended to be used in the early stages of plant development and then removed, but the supports are then intended to be stacked around each plant so as to provide continued structural support to the plant. A disadvantage of the systems of Anderson and Koziol is the amount of effort necessary to release the cover and secure it to the supports, as needs to be done each time one wishes to directly access the plants. Also, during the period that the cover is lifted, for venting or otherwise, the plants are exposed to insects and birds. Another disadvantage is that the cover is affixed to the supports at specific points, which concentrates the stress arising from wind and rain. With the stress thus concentrated, the cover is highly susceptible to tearing, and thus failing, potentially abruptly and completely.

Therefore, what is needed are a row cover device and method that do not require localized affixing of the cover nor weights at the edges of the cover to hold the cover down. What is further needed is such a device that maintains its structural integrity in the worst storms reasonably expected and that provides differing transparencies to sun and wind, as the gardener desires. What is yet further needed is such a device that affords the gardener easy access to the plants and allows the installation of a humidity-control system within the cover. In general, what is needed is such a device that is useful not only for providing protection against frost, but also throughout the frost-free growing season for providing protection from other hazards, while not interfering with the continued natural growth of the plants. Finally, what is needed is such a row cover that vents moisture and heat while protecting against insects.

### SUMMARY OF THE INVENTION

For the reasons mentioned above, it is an object of the present invention to provide protection for garden plants against the hazards of the environment, including, but not limited to, frost, wind, insects, high temperatures, flood, and drought. A further object is to provide this protection with a system that is not susceptible to destruction by high winds and heavy rains. A yet further object of the present invention is to provide the stated protection without unduly limiting the gardener's access to the plants being protected. A still further object of the present invention is to permit a modulated exposure of the plants to the immediate environment, so that when maximum protection against frost is not needed, the plants can benefit from closer contact with sunlight and the air surrounding the cover.

The present invention meets its stated objects by a new approach to the support end of the row protection cover. The supports are designed to hold down the cover, as well as support it. The supports are the standard semi-circular plastic elements present in certain prior-art systems. They present, however, a concave groove along their outward facing surfaces. In deploying the system of the present invention, these arch supports are set out along the row to be protected. The cover (which can consist of more than one component sheet) is then draped along and across the arches and, while it is held in place, an elastic bungee-like cord element is stretched across the surface of the cover at the location of each of the arches. This elastic element is tied to the ground by means of a tent stake or its equivalent, so that it presses down on the cover material, which, in turn, is driven down into the concave groove present in each arch.

The manner in which the cover of the present invention is secured gives rise to a number of benefits. For one, it eliminates the localized stress on the cover that is present in most traditional row cover systems—and it does so without the addition of weights along the edges of the cover. Furthermore, because of the elastic nature of the tie-down of the cover, it is trivial to lift up the edge of the cover to get access to the plants and then to push the cover back down again after the need for access is over. Unlike the prior art, nothing need be undone, detached, or loosened in order to gain access to the plants or, in general, to expose them to the ambient conditions to any degree, such as, for example, to vent the interior atmosphere for temperature or humidity control reasons.

Also following from the elastic-loaded nature of the tie-downs, it is possible to use compound covers. This is helpful for many reasons. For example, it may be desirable to have a heavy cover and a light cover, the former placed on top of the later. During periods of high risk of frost, or other extreme conditions, the heavy cover will be completely deployed, but during more moderate conditions, and when no frost is reasonably expected, the heavy sheet can be slid up and bunched toward the top of the arches, leaving the light cover to protect the plants. Alternatively, the light cover may consist of mesh, so that air freely flows through it when the heavy cover is stowed at the top of the arches. In this mode of operation, one may choose a mesh material that vents heat and moisture while continuing to exclude insects (and birds). The heavy cover is impervious to air and water and is lowered in anticipation of extreme conditions such as frost. As yet another alternative, the system may use a compound cover in which the heavy cover has attached to it the mesh cover in such a manner that the mesh overlays the heavy cover for most of the lower portion of the deployed cover.

The present inventor has found through experimentation, in which plants were grown within and without row covers of the type covered by the invention, that plants inside the cover benefit not just from protection against the frost, but also protection from other environmental factors, presumably stress from wind, rains, and insects. This is known since, even in the absence of early frost during the test, those plants growing within the cover matured much earlier (days, weeks) than those growing immediately outside under conditions that were as identical as the experimenter could make them.

### BRIEF DESCRIPTION OF THE DRAWINGS

FIG. 1 is a perspective view of the invention.

FIG. 2 is a side view of the invention.

FIG. 3 is an end view of the invention.

FIG. 4 is a detailed view of the elastic line in conjunction with a support arch in the Preferred Embodiment of the invention.

FIG. 5 shows details of the compound cover as configured in the Preferred Embodiment of the invention.

FIG. 6 shows the Preferred Embodiment configuration with the outer portion of the lower compound cover pushed up to allow venting of the enclosure.

FIG. 7 shows the Preferred Embodiment configuration with the entire lower portion of the compound cover pushed up to allow access to the plants within the enclosure.

### PREFERRED EMBODIMENT OF THE INVENTION

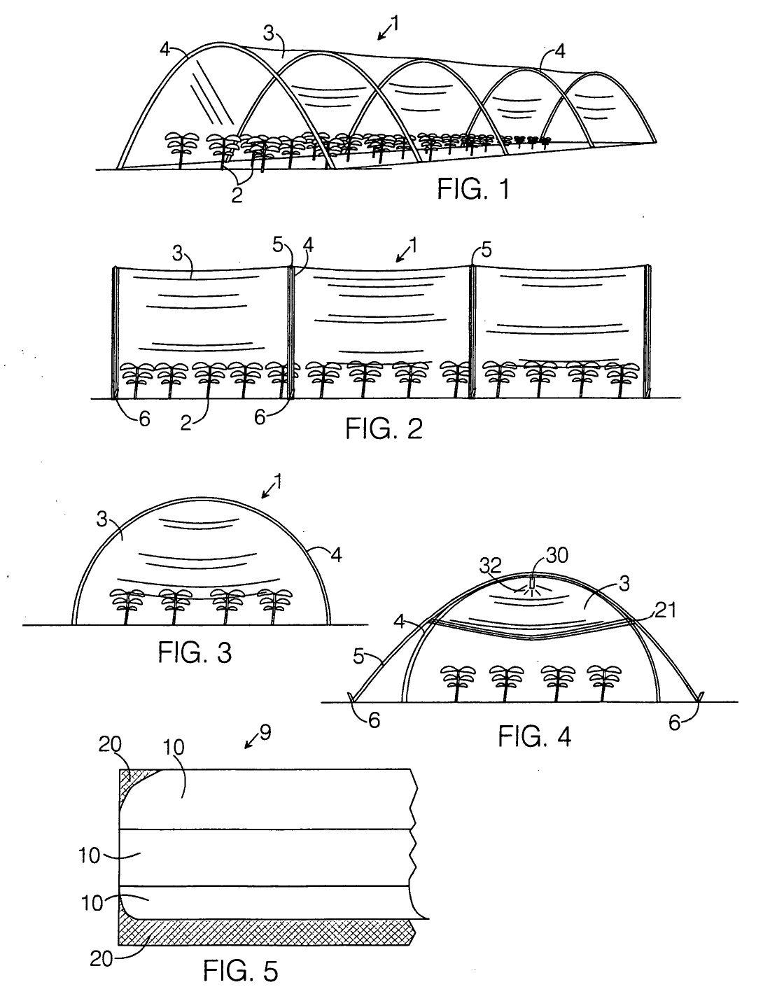

All of the key elements of the basic invention are shown in FIG. 1, which depicts the protective enclosure 1 deployed over and along several rows of garden plants 2. The protective enclosure 1 consists in major part of a translucent plastic cover 3 draped over a plurality of arch supports 4. As shown, at each of the supports 4, the cover 3 is pressed down onto the support by a hold-down 5, which in the Preferred Embodiment is a bungee cord. With continuing reference to FIG. 1, it can be seen that the hold-down 5 is affixed to the ground by a hold-down stake 6, which in the Preferred Embodiment is simply a miniature tent stake.

The compound cover 9 of the Preferred Embodiment is shown in FIG. 5. It consists of a base layer 10, which is a plastic sheet that is impervious to wind and rain. The base layer 10 defines the area and limits of the compound cover 9. Two additional panels, the ventilation panels 20, are sewn onto the side of the base layer 10 that is intended to face the inside of the protective enclosure 1, approximately one-third of the way across the base layer 10 coming from each direction. The ventilation panels 20, while filtering out insects and impervious to birds, freely passes air and moisture from the atmosphere outside of the protective enclosure 1.

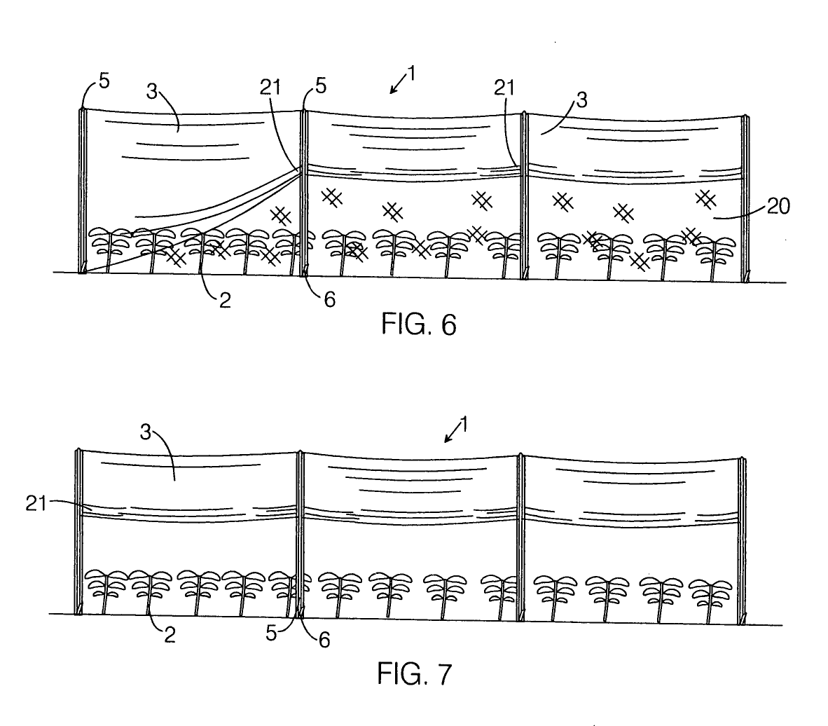

In use, the protective enclosure 1 is erected over the rows to be protected after the garden has been planted. In general, the garden will be planted and the protective enclosure 1 will be put in place on or before the date of the average final Spring frost, and is meant to protect against frost, though not an extended hard freeze. During the first part of the season, the compound cover 9 will be arranged so that the ventilation panels 20 are covered by the base layer 10. Nevertheless, even during the early part of the season, on particularly mild days, one may decide to bunch the lower part of the base layer 10 up under the hold-down 5 so that air can pass through each hold-down 5 and onto the plants, as shown in FIG. 6. As the season advances, the configuration depicted in FIG. 6 will become the default configuration, with the protective enclosure 1 moved to its more protective mode only when high winds, rain, or a rogue frost is anticipated.

For those times that the gardener needs to tend directly to the plants 2, the entire compound cover 9 is bunched up under the hold-down 5, forming a bunched-up portion 21, all as depicted in FIG. 7. Because of the tension in the hold-down 5, sufficient frictional forces are generated to hold the bunched-up portion 21 in place, without need for continuous intervention by the gardener. And yet, that frictional force is not so great as to interfere with the gardener's pulling down the ventilated panels 20 after the desired procedure with the plants 2 is complete.

The Preferred Embodiment also includes means for delivering mist to the plants 2 within the protective enclosure 1. This is shown in FIG. 8.

Although the details of one particular embodiment of the present invention have been set out above, there is no intention to thereby limit the scope of the invention. The invention rather is described in the SUMMARY and also encompasses numerous variations and embodiments that a person skilled in the craft can think of after having read the SUMMARY.

I claim:

1. A protective enclosure for a row of garden plants sewn in the soil out-of-doors, said enclosure comprising:
a plurality of semi-circular arches for spanning and extending along said row in a plurality of arch positions, each of said arches having a first arch end and a second arch end,
a cover, wherein said cover has a cover inside and a cover outside, and wherein said cover is drapable over said plurality of arches with said cover inside facing said plants,
a plurality of hold-downs each having a first hold-down end and a second hold-down end and each being extendable down over said cover outside at one of said arch positions, so that said hold-down holds said cover firmly on said arch.

2. The enclosure described in claim 1, wherein said first arch end is insertable into said soil on a left side of said row and said second arch end is insertable into said soil on a right said of said row.

3. The enclosure described in claim 2, wherein said hold-downs are made of elastic material and of such a length that said hold-downs are under tension when in use in said enclosure.

4. The enclosure described in claim 3 adapted so that said first hold-down end is to be anchored near said first arch end and said second hold-down end is to be anchored near said second arch end.

5. The enclosure described in claim 4, wherein both said first hold-down end and said second hold-down end are adapted to be anchored on said arch.

6. The enclosure described in claim 5 wherein said cover includes a base shield and two ventilation panels.
